(19) United States
(12) Patent Application Publication
(10) Pub. No.: US 2008/0079570 A1
(43) Pub. Date: Apr. 3, 2008

(54) Door Status Indicator System

(76) Inventors: Sanford Fineman, Scotch Plains, NJ (US); Michael W. Starkweather, Sandy, UT (US)

Correspondence Address: ADVANTIA LAW GROUP, 9035 SOUTH 1300 EAST, SUITE 200, SANDY, UT, 84094, US

(21) Appl. No.: 11/537,299

(22) Filed: Sep. 29, 2006

(51) Int. Cl. G08B 13/08

(52) U.S. Cl. 340/545.1

(57) ABSTRACT

A door status indicator system for indicating the status of a garage door. The system includes: a door sensor module, configured to sense an open mode of a door; a transmitter module, configured to transmit a signal; a receiver module, configured to receive a signal; a data storage module, configured to store time information; and a a display module, configured to display time information. The receiver module is a cellular phone that includes audio alert module configured to provide an audio alert. The system also includes: a video capture module, configured to capture video of an interior of a garage; and a remote control module, configured to control closing of a door from a remote location.

### BACKGROUND OF THE INVENTION

1. Field of the Invention

The present invention relates to a garage door opening and status indicator systems, specifically a garage door status indicator system.

2. Description of the Related Art

In the related art, it has been known to use garage door openers and status indicators for the purpose of opening and closing garage doors, as well as for indicating whether a user's garage door is opened or closed. It is well known that a garage door may be operated into an open or closed position by a motorized system which may be activated by a switch disposed on a wall, or by a remote controller.

Many homeowners are able to back their automobiles out of their driveways; manipulate a remote controller to close their garage doors; and leave their residences before they ever recognize whether or not their garage door is in the fully closed and secured position. Afterwards, the homeowner begins to worry about whether or not his or her garage door is closed and secure. Since garage doors are often attached to a user's residence, garage doors are increasingly becoming a way for criminals to gain access to residential homes. Even if the garage is a separate structure, valuable tools and equipment are often left there. These tools and equipment could be stolen easily if a burglar gained access to the garage. Frequently, such access is obtained simply because the automobile operator either forgot to close the garage door or did not realize the garage door was open. Some improvements have been made in the field to resolve these issues. Examples include but are not limited to the references described below, which references are incorporated by reference herein:

U.S. Pat. No. 6,070,361, issued to Paterno, a garage door operating system which includes a garage door, framing along which the garage door is positioned and travels between non-closed and closed positions, a signal generator which transmits a closed and or non-closed signal depending upon the position of the garage door, and finally includes an indicator which provides a suitable indicator signal upon receiving the signal.

U.S. Pat. No. 4,583,081, issued to Schmitz, discloses a door operator system includes up and down limit switches actuated to the closed position when the door reaches the up and down travel limits. A processor circuit within the operator is connected to the limit switches for ascertaining the position of the door. Bias circuits apply a bias to the processor when the limit switches are open. An indicator system comprising a pair of light emitting diodes connected across respective limit switches indicates the door position. A series impedance element common to both LED circuits prevents actuation of the control circuit by the light emitting devices.

U.S. Pat. No. 5,689,236, issued to Kister, discloses a remote garage door position indicator comprises a magnetic sensor device; a transmitter device being operatively coupled to the magnetic sensor device, the transmitter device being capable of transmitting electronic signals; a signal interruption device including a plate extending therefrom, in closed orientation the outer plate of the receiver device engaging the magnetic sensors of the sensor device thereby closing the electrical circuit and causing the transmitter device to cease sending electronic signals; and a garage door position indicator including a power source and a light, the position indicator including a receiver means capable of receiving electronic signals from the transmitter device, when receiving electronic signals from the transmitter the receiver device causing the light to illuminate, in the closed orientation the transmitter device does not emit electronic signals thereby preventing the receiver device from illuminating the light, users viewing the light of the position indicator to determine whether their garage door is opened or closed.

U.S. Pat. No. 5,883,579, issued to Schreiner et al., discloses a system which will activate an alarm when a garage door is opened. The system in a transmitter unit and a receiver unit. The transmitter unit is attached in proximity to the garage door. The receiver unit is located within a vehicle stored in the garage. The transmitter unit includes a signal generator which activates and transmits radio frequencies (RF) to the second unit. For activation, once the garage door is in an opened position, the transmitter sends a signal to the receiver. The receiver activates an alarm.

U.S. Pat. No. 5,798,681, issued to Chang, discloses a garage door position indicator contains a radio frequency (RF) transmitter with an electronic angle sensor attached onto a garage door, and a RF receiver with a visual/audio indicator. The electronic angle sensor supplies signals to the RF transmitter during the changes in orientation of a garage door from vertical to horizontal and from horizontal to vertical. The RF receiver is responsive to the RF signals from the RF transmitter and controls a visual/audio indicator to indicate the position of a garage door accordingly.

U.S. Design Pat. No. D380,696, issued to Doppelt et al., discloses a ornamental design for a transmitter for garage door opener.

The inventions heretofore known suffer from a number of disadvantages which include: being expensive; being inconvenient; being difficult to install; incapable of capturing photographs of a structure; and/or being unable to leverage advanced technology.

What is needed is a door status indicator system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available garage door opening and status indicator systems. Accordingly, the present invention has been developed to provide a door status indicator system for indicating the status of a garage door.

There is an embodiment of a door status indicator system for indicating the status of a garage door. The system may include: a door sensor module, that may be configured to sense an open mode of a door; a transmitter module, that may be in communication with the door sensor module, and/or may be configured to transmit a signal; a receiver module, that may be in communication with the transmitting module, and/or may be configured to receive a signal; a data storage module, that may be in communication with the receiving module, and/or may be configured to store time information; and a display module, that may be in communication with the data storage module, and/or may be configured to display time information.

In one embodiment of the present invention, the door status indicator system, for indicating the status of a garage door, may include a receiver module that may be in the form of a cellular phone, wherein the cellular may have an audio alert module that may be configured to provide an audio alert.

Another embodiment of the present invention may include: a video capture module that may be in communication with the display module, and/or may be configured to capture video of an interior of a garage.

In yet another embodiment, there may be a remote control module that may be coupled to the receiver module, and/or configured to control closing of a garage door from a remote location.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a front perspective view of a door status indicator system, according to one embodiment; and

FIG. 2 is a block diagram of a door status indicator system; according to one embodiment.

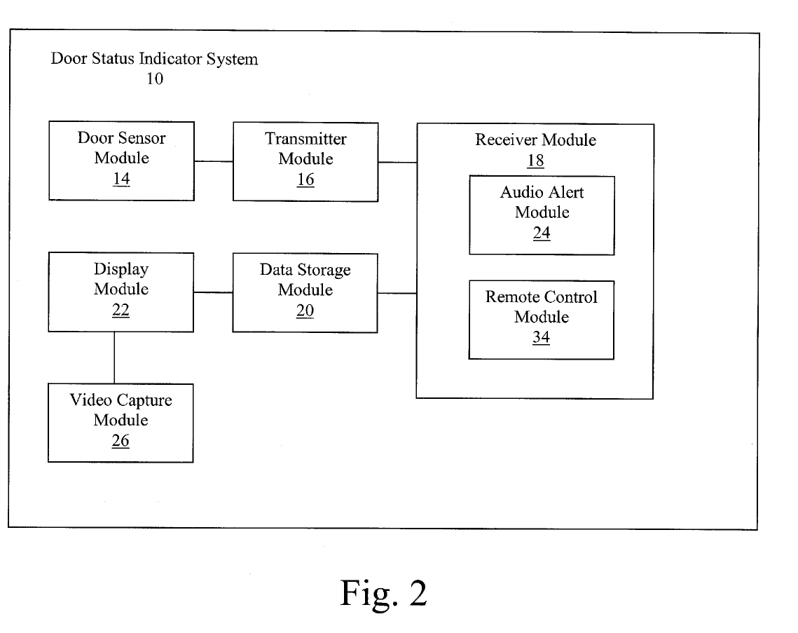

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Looking to the figures, there is an embodiment of a door status indicator system 10 for indicating the status of a garage door 12. The illustrated system 10 includes: a door sensor module 14 configured to sense an open mode 30 of a door; a transmitter module 16 in electrical communication with the door sensor module, and configured to transmit a signal. Non-limiting examples of a door sensor module 14 and transmitter module 16 are described in U.S. Pat. No. 5,883,579 issued to Schreiner et al. and U.S. Pat. No. 5,883,579 issued to Chang, which are incorporated by reference herein.

The illustrated embodiment of the system 10 also includes a receiver module 18 in radio communication with the transmitter module 16, and configured to receive a radio frequency (RF) signal 28 therefrom; a data storage module 20 in communication with the receiving module, and configured to store time information; and a display module 22 in communication with the data storage module, and be configured to display time information. Non-limiting examples of the data storage module may include a memory chip, computer hard disk drive, etc. In addition to having the data storage module, the system includes a display module 22 that may be in the form of a LED screen, computer graphical user interface, etc., and configured to display time information that includes, but is not limited to: a time log, the time of day the garage door(s) 12 was opened, etc.

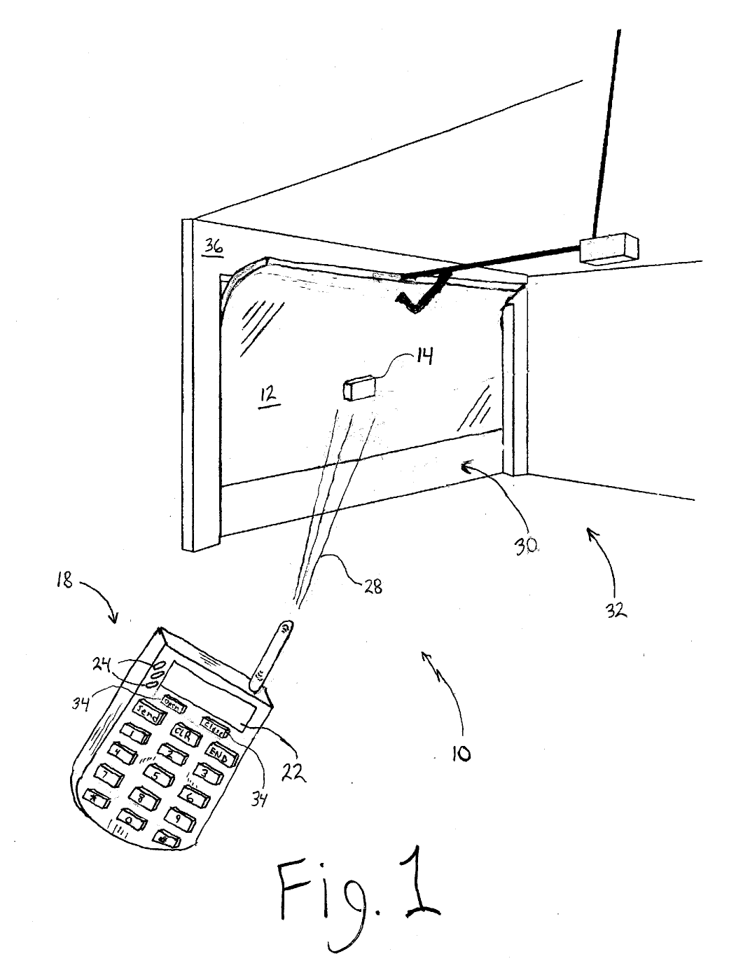

In one embodiment of the present invention, the receiver module 18, as shown in FIG. 1, is in the form of a cellular phone having a remote control module 34 coupled thereto. The remote control module 18 is configured to control the opening and closing of a garage door 12 from a remote location. A non-limiting example of a remote control module 34 is described in U.S. Pat. No. 5,689,236 issued to Kister, which is incorporated by reference herein. In alternative embodiments, the remote control module 34 may be coupled to other forms of receiver modules. For example, personal digital assistants (PDAs), laptop computers, desktop computers, etc.

Additionally, the receiver module 18, as shown in FIG. 1, includes an audio alert module 24 disposed therein. The audio alert module 24 is configured to provide an audio alert, and serves as a medium to warn the user that his or her garage door 12 is in a cracked or open mode 30. A non-limiting example of an audio alert module may be a speaker.

Another embodiment of the present invention may include: a video capture module 26 in communication with the display module 22 and configured to capture a real-time video of an interior 32 of a garage and show whether the garage door(s) 12 and/or other devices, such as entrance door into a structure 36 is open or closed, and/or if any valuables may be missing from an unsecured garage. A non-limiting example of a video capture module may be a camera. The video photograph may be transmitted via RF signals from the transmitter module 16 to the cellular phone 18 and/or other forms of receiver modules, according to various embodiments. Moreover, the photographs of the interior 32 of the garage may be displayed on the display module 22 coupled to the cellular phone 18 and/or other forms of receiver modules, according to various embodiments.

In yet another embodiment of the present invention, the system 10 may include a remote control module 34 having a visual indicator disposed thereon, and configured to glow red to indicate a cracked or open garage door and green when the garage door is closed and secured.

In operation of the illustrated embodiment of the door status indicator system 10, the door sensor module 14 includes a motion sensor that senses whether the garage door is in a cracked or open mode 30 and/or closed mode. During instances where a user inadvertently forgot to close his or her garage door 12, the motion sensor would signal the transmitter module 16 and video capture module 26 that the garage door 12 is open or unsecured. The camera 26 would then be activated and capture a video photograph of the interior of the user's garage. The transmitter module then will generate/transmit the video photographs and other data, in the form of a RF signal, to the cellular phone 18.

Once the cellular phone receives the RF signal, an audio sound from the audio alert module alerts the user that his or her garage door 12 is in the cracked or open mode 30. In other embodiments, the cellular phone will ring like an ordinary phone call to let the user whether the garage door is open or closed, and/or display the select hours of the day when the garage door is in the cracked or open mode. In addition, the video photograph and other data are stored into the cellular phone's data storage module 20, and is displayed on cellular phone's display module 22. The user then could determine the time of day when the garage 12 door is open or unsecured, as well as see whether or not any valuable belongings are missing from the garage.

Likewise, the system functions as described in paragraphs 36 and 37, alerting the user whenever his or her the garage door is in the closed or secured mode.

An embodiment of the garage door status indicator system 10 fulfills the need for a device that warns a user as to whether or not his or her garage door 12 is in the cracked or open mode 30. This enables the user to take appropriate measures to ensure the proper security of his or her garage door, thereby preventing potential burglars from coming on to the property and stealing valuable supplies or equipment in the garage and/or illegally entering into the residential property.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Although FIG. 1 illustrates the door sensor module 14 being disposed near the center of the garage door 12, the door sensor module may be disposed anywhere on the garage door, according to various embodiments.

Additionally, although FIG. 1 illustrates the door sensor module 14 transmitting a signal 28 to the receiver module 34 in the form of a cellular phone 18, the door sensor module may transmit similar signals to other forms of receiver modules, according to various embodiments. For example, personal digital assistants, computers, remote controllers, etc.

Further, although FIG. 1 illustrates the door sensor module 14 being disposed on one garage door 12, it is envisioned that the door sensor module may be disposed on more than one garage door, according to alternative embodiments. For example, structures 36 having two garage doors, structures having three garage doors, etc.

It is expected that there could be numerous variations of the design of this invention. An example is that the door sensor module 14; display module 22; audio alert module 24; and/or remote control module 34, as shown in FIG. 1, may vary in appearance, length, width, size, shape, etc., according to various embodiments.

Finally, it is envisioned that the components of the device may be constructed of a variety of materials. For example, plastic, composite material, metal, metal alloys, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A door status indicator system for indicating the status of a garage door, comprising:
a) a door sensor module, configured to sense an open mode of a door;
b) a transmitter module, in communication with the door sensor module, and configured to transmit a signal;
c) a receiver module, in communication with the transmitting module, and configured to receive a signal;
d) a data storage module, in communication with the receiving module, and configured to store time information; and
e) a display module, in communication with the data storage module, and configured to display time information.

2. The door status indicator system of claim 1, wherein the receiver module is a cellular phone.

3. The door status indicator system of claim 2, wherein the cellular phone includes an audio alert module configured to provide an audio alert.

4. The door status indicator system of claim 3, further comprising:
a) a video capture module, in communication with the display module, configured to capture video of an interior of a garage.

5. The door status indicator system of claim 4, further comprising:
a) a remote control module, coupled to the receiver module, configured to control closing of a door from a remote location.

6. A door status indicator system for indicating the status of a garage door, comprising:
a) a door sensor module, configured to sense an open mode of a door;
b) a transmitter module, in communication with the door sensor module, and configured to transmit a signal;
c) a receiver module, in communication with the transmitting module, and configured to receive a signal;
d) a data storage module, in communication with the receiving module, and configured to store time information; and
e) a display module, in communication with the data storage module, and configured to display time information.

7. The door status indicator system of claim 1, wherein the receiver module is a cellular phone.

8. The door status indicator system of claim 2, wherein the cellular phone includes an audio alert module configured to provide an audio alert.
